(19) United States
(12) Patent Application Publication
(10) Pub. No.: US 2016/0114616 A1
(43) Pub. Date: Apr. 28, 2016

(54) METHOD AND APPARATUS FOR RESURFACING CUTTING BOARDS

(71) Applicant: Patrick Michael BERTRAND, SR., Wilmington, NC (US)

(72) Inventor: Patrick Michael BERTRAND, SR., Wilmington, NC (US)

(21) Appl. No.: 14/520,461

(22) Filed: Oct. 22, 2014

(51) Int. Cl. B44C 1/22; B27C 1/10; B23D 9/00; B27G 13/04

(52) U.S. Cl. CPC B44C 1/222; B27G 13/04; B27C 1/10; B23D 9/00

(57) ABSTRACT

An apparatus and method for resurfacing polyethylene cutting boards is provided. The apparatus includes a modified planer blade used in the process of applying a small planer in crisscrossing paths across the cutting boards.

### BACKGROUND OF THE INVENTION

The present invention relates to cutting boards and, more particularly, to an apparatus and method for resurfacing polyethylene cutting boards.

Currently, when medium density polyethylene (MDPE) and high density polyethylene (HDPE) cutting boards become damaged from knife cuts, stained, harboring bacteria, or otherwise overused they are either thrown out or alternatively refurbished using an expensive and ineffective process.

The current process is problematic in several ways. First it involves large equipment requiring commensurate power consumption: typically a 30″ wood planer where the cutting boards are run through; such equipment is loud and requires a massive generator. Second, the resulting refurbished cutting boards tend have a finishes that are too smooth and too slick, as the current process removes more surface than necessary.

As can be seen, there is a need for a process involving a less powerful, inexpensive planer that creates a textured finish.

### SUMMARY OF THE INVENTION

In one aspect of the present invention, a method of resurfacing a polyethylene surface comprises the steps of: providing a modified planer blade, wherein the modified blade comprises a generally concaved modified edge, and wherein the modified edge is defined by an inclination angle that ranges from about 1 degree and 55 minutes degrees to about 2 degrees and 15 minutes degrees as the modified edge extends toward each opposing end thereto; attaching the modified planer blade to a planer; and planing the polyethylene surface until a suitable textured surface develops.

In another aspect of the present invention, planer blade configured to resurface a polyethylene surface comprises: a generally rectangular sheet of material of suitable hardness, wherein the sheet provides a generally concaved modified edge, and wherein the modified edge is defined by an inclination angle that ranges from about 1 degree and 55 minutes degrees to about 2 degrees and 15 minutes degrees as the modified edge extends toward each opposing end thereto.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a perspective view of an exemplary embodiment of a modified planer blade of the present invention;

FIG. 3 is a front view of an exemplary embodiment of the modified planer blade of the present invention;

FIG. 4 is a top prior art view illustrating an unfinished board;

FIG. 5 is a top view of an exemplary embodiment of the present invention, illustrating an exemplary tool path;

FIG. 6 is a top view of an exemplary embodiment of the present invention, illustrating an exemplary tool path;

FIG. 7 is a top view of an exemplary embodiment of the present invention, illustrating an exemplary tool path;

FIG. 8 is a top view of an exemplary embodiment of the present invention, illustrating an exemplary tool path;

FIG. 9 is a side view of an exemplary embodiment of the present invention, illustrating an exemplary process; and

FIG. 10 is a schematic overview of an exemplary embodiment of the present invention, illustrating an exemplary process.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an apparatus used in the process of resurfacing polyethylene cutting boards. The apparatus includes a modified planer blade used in the process of applying a small planer in crisscrossing paths across the cutting boards.

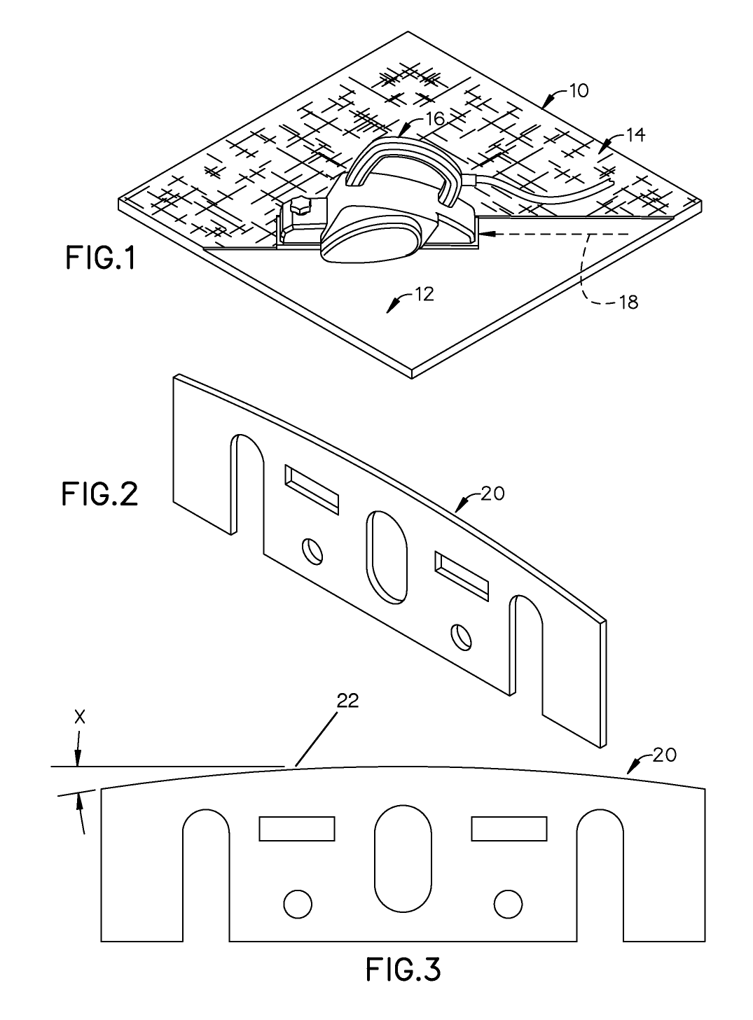

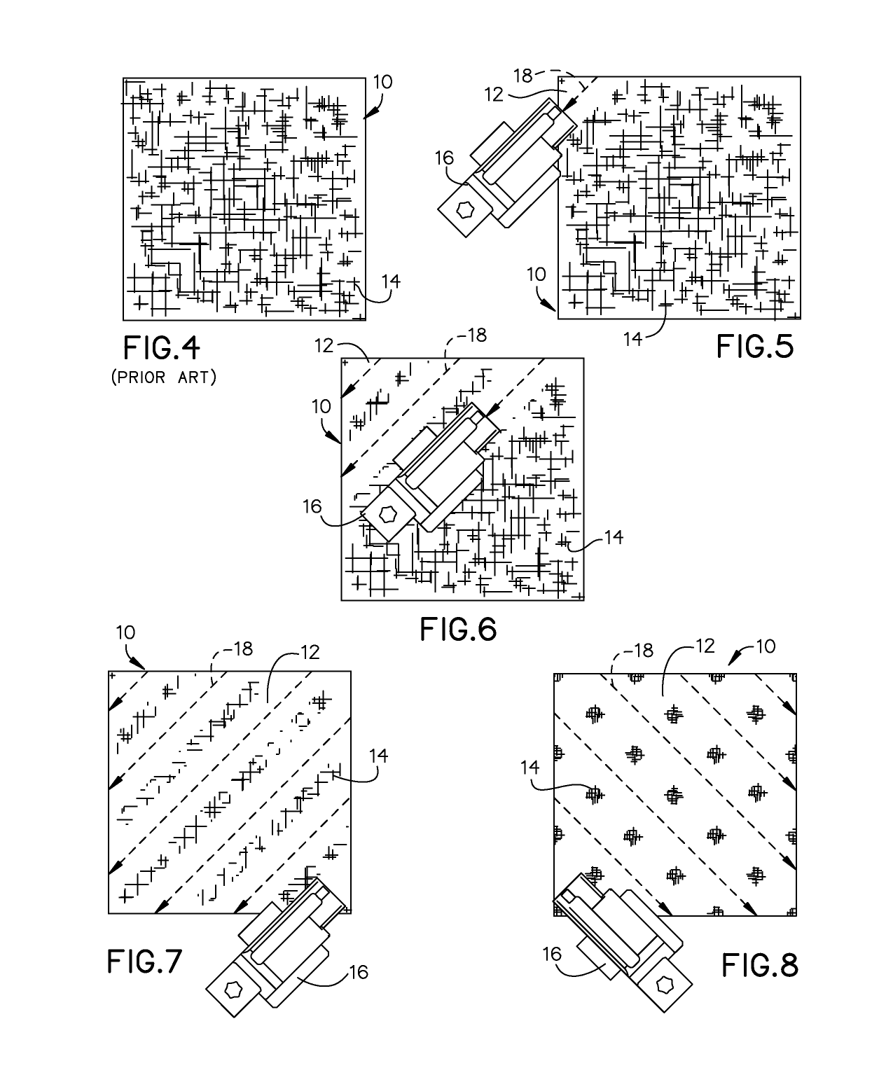

Referring to FIGS. 1 through 10, the present invention may include a modified planer blade 20 used in a process of resurfacing polyethylene cutting boards 10.

The modified planer blade 20 may be a generally rectangular elongated planar sheet of material of suitable hardness. The elongated sheet may provide a plurality of cutouts and apertures for attaching to the suitable planer 16. The blade 20 may provide a modified edge 22 along the length of one side of the blade. The modified edge 22 will be generally concaved as the modified edge 22 extends toward each opposing end, as illustrated in FIG. 3. Preferably, the concaved edge may be defined by an inclination angle X that ranges from about 1 degree and 55 minutes degrees to about 2 degrees and 15 minutes degrees. The “inclination angle” means an angle of a tangential line at an arbitrary point on the modified edge relative to a true “rectangular line.”

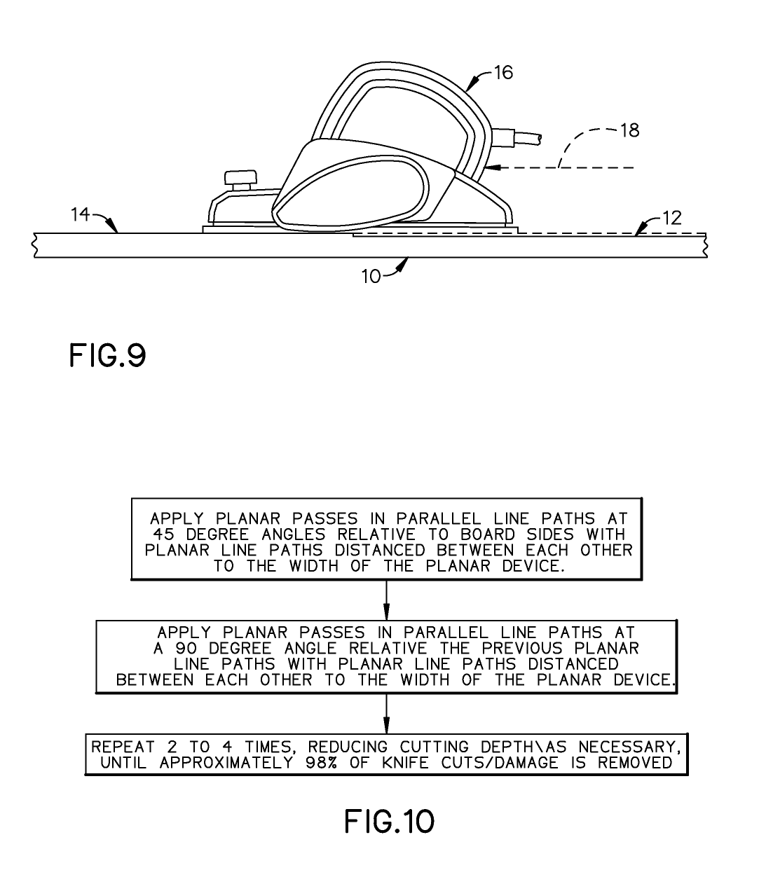

The user may attach the modified planer blade 20 to the suitable planer 16 so that the modified edge 22 is downwardly facing the cutting board 10. The user may place the cutting board 10 on a surface, such as a table, wherein the surface preferably has a non-skid surface. Then the user may apply the planer 16 to the cutting board 10, working generally diagonal tool paths 18 across the cutting board 10 so that the paths 18 are suitably spaced apart a predetermined distance, as illustrated in FIGS. 5 through 7. In certain embodiments, the predetermined distance may be generally the width of the planer 16. The tool path 18 works a relatively unshaven surface 14 into a more shaven surface 12, as illustrated in FIG. 9.

Then the user may apply a new set of tool paths 18 at about 90 degrees relative to the previous tool path 18, wherein the new set of tool paths 18 are suitably spaced apart a predetermined distance, as illustrated in FIG. 8. Then the user repeats 2 to 4 more times, so that a predetermined amount of the unshaven surface 14 has been removed and/or resulting in a textured finish. In certain embodiments, the predetermined amount of the unshaven surface 14 may be when approximately 98% of the knife cuts/damage has been removed.

Because the method only removes the surface that is necessary, it can be done many times, depending on surface damage and thickness. The user may reduce cutting depth as necessary.

In certain embodiments, the method is adapted to remove bacteria-laden surfaces from the cutting board 10.

The user may apply a deburring tool to smooth the edges, as well as a broom and dustpan to clean up residual material.

In certain embodiments, the method can be adapted to produce a cutting board rack.

It should be understood, of course, that the foregoing relates to exemplary embodiments of the invention and that modifications may be made without departing from the spirit and scope of the invention as set forth in the following claims.

What is claimed is:

1. A method of resurfacing a polyethylene surface, comprising the steps of:
providing a modified planer blade, wherein the modified blade comprises a generally concaved modified edge, and wherein the modified edge is defined by an inclination angle as the modified edge extends toward each opposing end thereto;
attaching the modified planer blade to a planer; and
planing the polyethylene surface until a suitable textured surface develops.

2. The method of claim 1, wherein the inclination angle ranges from about 1 degree and 55 minutes degrees to about 2 degrees and 15 minutes degrees.

3. The method of claim 1, further providing planing the polyethylene surface in successive diagonal paths so that the diagonal paths are suitably spaced apart a predetermined distance.

4. The method of claim 3, wherein the predetermined distance is about a width of the modified planer blade.

5. The method of claim 3, further providing planing the polyethylene surface in successive new paths generally normal to the diagonal paths so that the new paths are suitably spaced apart the predetermined distance.

6. The method of claim 5, further providing repeating the crisscrossing diagonal paths and the new paths so that the entirety of the polyethylene surface develops suitable textured surface.

7. A planer blade configured to resurface a polyethylene surface, comprising:
a generally rectangular sheet of material of suitable hardness, wherein the sheet provides a generally concaved modified edge, and wherein the modified edge is defined by an inclination angle as the modified edge extends toward each opposing end thereto.

8. The planer blade of claim 7, wherein the inclination angle ranges from about 1 degree and 55 minutes degrees to about 2 degrees and 15 minutes degrees.
